(19) United States
(12) Patent Application Publication
(10) Pub. No.: US 2008/0155559 A1
(43) Pub. Date: Jun. 26, 2008

(54) PORTAL EVENTING DIRECTORY

(76) Inventor: Ilja Fischer, Bad Schoenborn (DE)

Correspondence Address: KENYON & KENYON LLP, 1500 K STREET N.W., WASHINGTON, DC, 20005, US

(21) Appl. No.: 11/614,571

(22) Filed: Dec. 21, 2006

(51) Int. Cl. G06F 9/44

(52) U.S. Cl. 719/318

(57) ABSTRACT

The present invention provides methods and systems for maintaining consistency in portal namespaces and portal event naming. Some embodiments provide a way for developers to select an appropriate portal event when working in a specific namespace. Similarly, some embodiments allow developers to determine what namespaces are available for a given portal. Developers may also define new namespaces and portal events that can later be used by other developers.

### BACKGROUND

In a system implementing object-based navigation, portal views allow users to interact with business objects and applications. A portal, such as a web browser, displays various portal views containing interfaces to business objects, applications, and other structures or programs. Developers may specify portal events for each portal view. A portal event generally is an operation performed within a portal. For example, portal events may cause changes to applications displayed in the portal based on user actions. Similarly, portal events may pass information to or from applications or business objects. When a developer defines a portal event for a portal view, the portal event has a namespace associated with it. Generally, a namespace informs a developer of the scope in which a portal event is valid. A namespace may have, for example, variables and data structures associated with it. Portal events defined in a namespace may then have access to those variables and data structures.

When developers define portal events, they may create new namespaces and portal event names or they may use previously-created namespaces, portal events, and/or portal event names. This can lead to inconsistent naming schemes, portal event scopes, and functionality. For example, two developers may each define a portal event having the same name, but defined in different namespaces. The portal events may perform different functions, leading to confusion when later developers attempt to determine how, if at all, the two portal events are related. Similarly, a developer may create a new namespace and/or portal event with the same or similar function to a previously-defined namespace or portal event, leading to unnecessary duplication of functionality. A developer may also want to make a new portal event or namespace with a specific name, but may be prevented from doing so due to a previously-defined portal event or namespace having different functionality.

Given the problems described above, there is a need for systems and methods that maintain consistency of namespaces and portal event names between developers in different departments, organizations, or systems.

### BRIEF DESCRIPTION OF THE DRAWINGS

FIG. 1 is an illustration of portal events designed using a portal eventing directory according to an embodiment of the invention.

FIG. 2 is an illustration of portal eventing scenarios designed using a portal eventing directory according to an embodiment of the invention.

FIG. 3 is an illustration of portal eventing scenarios designed using a portal eventing directory according to an embodiment of the invention.

FIG. 4 is a process for creating portal events according to an embodiment of the invention.

FIG. 5 shows a process for maintaining consistency among portal event namespaces according to an embodiment of the invention.

FIG. 6 shows a user interface for maintaining consistency among portal event namespaces and names according to an embodiment of the invention.

### DETAILED DESCRIPTION

The present invention provides methods and systems for maintaining consistency in portal namespaces and portal event naming. Some embodiments provide a way for developers to select an appropriate portal event when working in a specific namespace. Similarly, some embodiments allow developers to determine what namespaces are available for a given portal. Developers may also define new namespaces and portal events that can later be used by other developers.

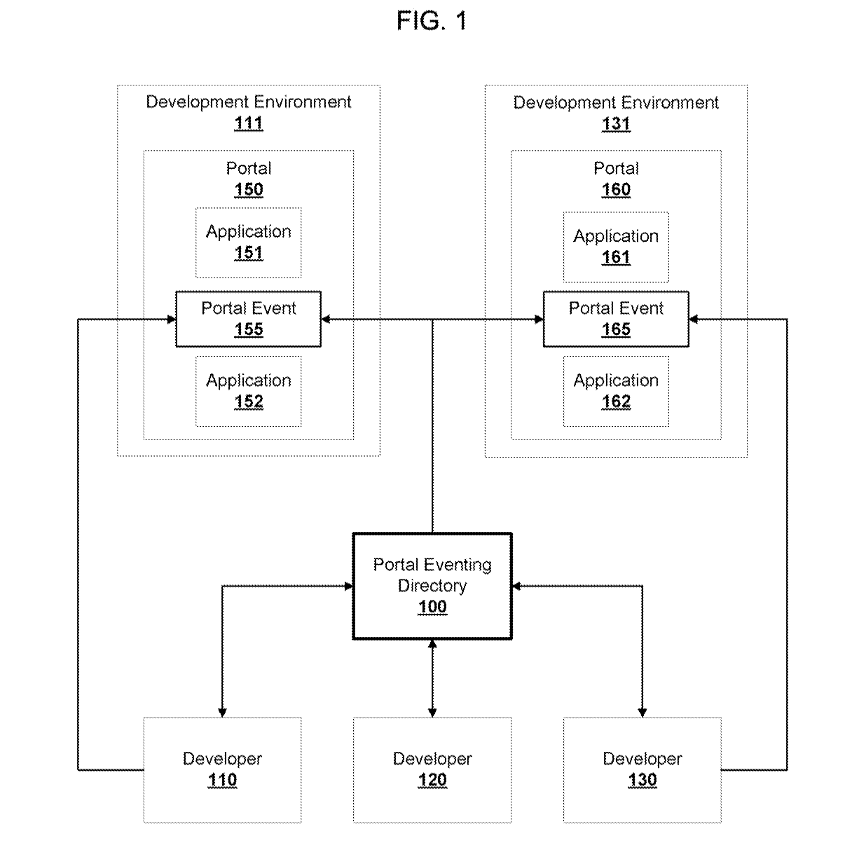

In embodiments of the invention, a developer creating a new portal event namespace or a new portal event may use a portal eventing directory to determine an appropriate namespace or portal event name. FIG. 1 shows how developers may use a portal eventing directory 100 to develop portal events 155, 165. Developers 110, 120, 130 may design portals 150, 160 and applications 151, 152, 161, 162 for use in a business system. The portals and applications may be designed in an integrated development environment 111, 131. When designing applications and portals, developers may create portal events 155, 165 for use in the portals. For example, a portal event 155 may be created that performs an operation in an application 151 or 152 in response to a user action. In order to determine an appropriate namespace for a portal event 155 or 165, a developer 110 or 130 may consult a portal eventing directory 100. Multiple developers may use the same portal eventing directory, in order to maintain consistency across, for example, different departments within an organization or different independent vendors.

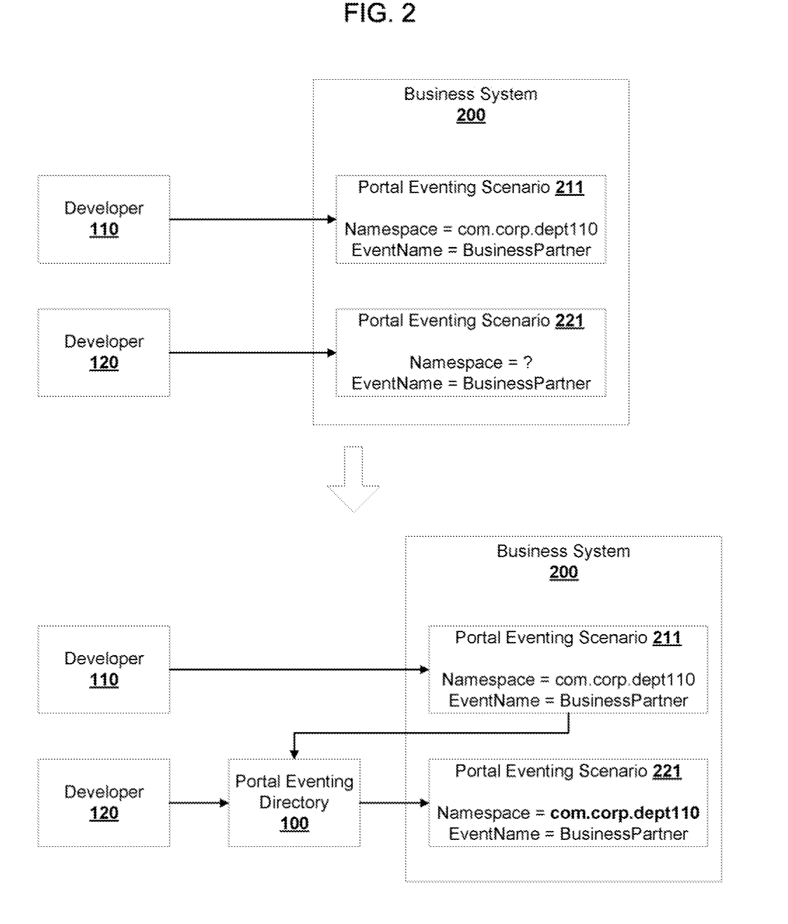

FIG. 2 shows an example process for maintaining consistency in portal namespaces and portal event names according to embodiments of the invention. Two developers 110 and 120 may create portal eventing scenarios, 211 and 221 respectively, within the same business system 200. A portal eventing scenario is a portal event (such as “BusinessPartner”) in a given namespace. In the example shown in FIG. 2, a developer 110 may define a portal eventing scenario 211 having the portal name BusinessPartner in the namespace com.corp.dept110. The namespace may be chosen by the developer 110, and may reflect naming conventions designed to indicate the purpose, origin, or other information about the namespace. For example, the namespace shown for the portal event 211 may indicate that the namespace is designed for use by “department 110” (dept110) within “corporation” (corp). Other naming conventions are possible. The developer 110 may store a record of the portal event name, namespace, and other information about the portal eventing scenario 211 in a portal eventing directory 100. When a second developer 120 wants to use a similar portal eventing scenario 221 in the business system 200, he may specify the portal event name (“BusinessPartner”) he wishes to use. The portal eventing directory 100 may then provide an appropriate namespace (com.corp.dept110) to maintain consistency between the portal eventing scenarios created by the first 110 and second 120 developers. The portal eventing scenario 221 defined by a later developer 120 may be the same or a similar portal eventing scenario 211 as defined by a prior developer 110, and therefore have the same namespace and portal event. The second portal eventing scenario 221 may also be a new scenario that uses the same namespace or portal event as a previous scenario. In such a case, a developer 120 may use the portal eventing directory to determine an appropriate namespace and/or portal event for use in the scenario.

Similarly, a developer may indicate a specific namespace, such as com.corp.dep110 to the portal eventing directory 100 and then select an appropriate portal event, such as BusinessPartner, when creating a portal event, portal, or other item in the business system. The portal eventing directory 100 may contain information about namespaces and portal events in the business system for which the developer or developers 110, 120 are designing portal events.

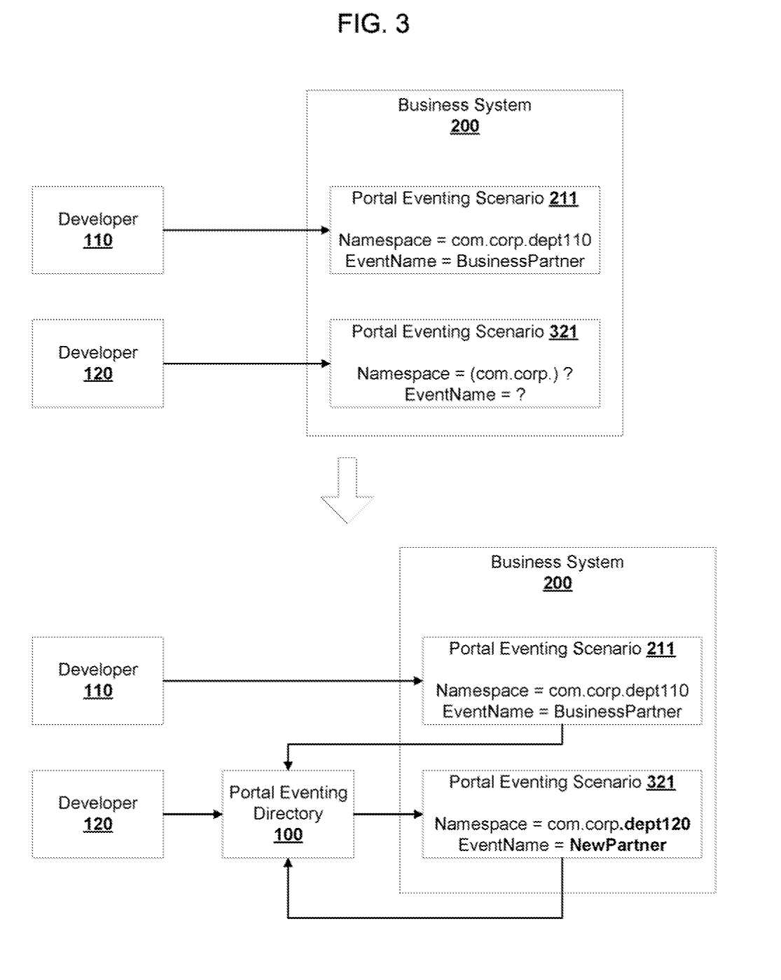

In some embodiments of the invention, a developer may also select some or all of a namespace, or select a portal event or event name based on a namespace. FIG. 3 shows various examples of how a developer may use a portal eventing directory 100 to maintain consistency of portal event namespaces and portal events. As described with respect to FIG. 2, one or more developers 110, 120 may define various portal eventing scenarios 211, 321 in a business system 200. The portal eventing scenarios may use various portal event namespaces, such as com.corp.dep110, and various portal events, such as BusinessPartner. When designing a portal eventing scenario, a developer 120 may use a portal eventing directory 100 to determine what namespaces and portal events have already been defined for use in the business system 200. For example, a developer creating a portal eventing scenario 221 may use part or all of a previously defined namespace, and/or a previously-defined portal event to construct a new portal eventing scenario. In the example shown in FIG. 3, a developer 120 may select an appropriate namespace or part of a namespace, such as “com.corp.”, by examining previously-defined namespaces stored in a portal eventing directory. The developer may then use the previously-defined namespace (com.corp.dept110) to determine an appropriate namespace (com.corp.dept120) for the new portal eventing scenario. Similarly, the developer may determine if there is a previously-defined portal event suitable for a new portal eventing scenario. If no appropriate portal event exists, the developer may create a new portal event, such as “NewPartner” in FIG. 3. Information about new portal events and/or namespaces created by a developer may then be stored in the portal eventing directory 100. For example, after a second developer 120 creates an appropriate namespace and/or portal event such as “com.corp.dept120” and “NewPartner”, information about any new namespaces and/or portal events may be stored in the portal eventing directory 100.

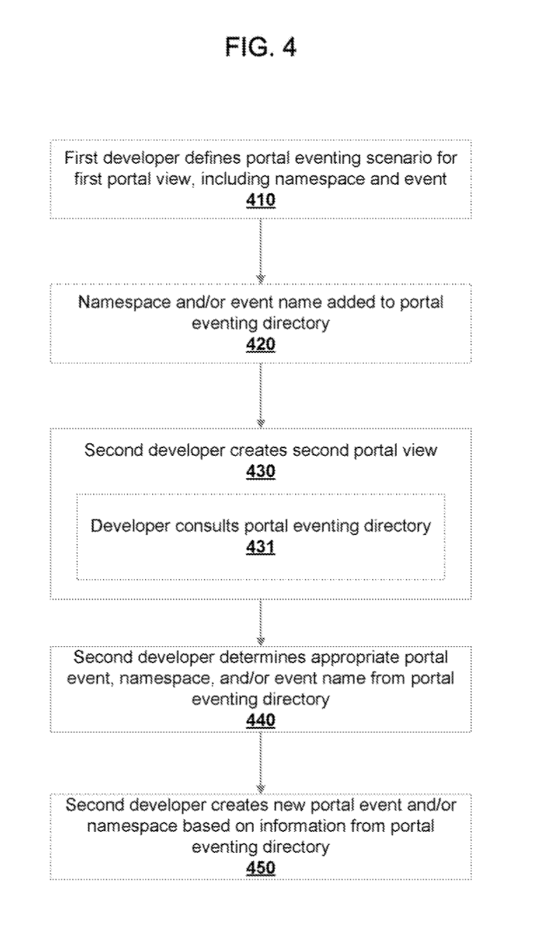

A process for maintaining consistency among portal event namespaces and/or portal events is illustrated in FIG. 4. A developer may define a portal eventing scenario, portal event namespace, and/or a portal event 410. Information about namespaces and/or portal events created may be added to a portal eventing directory 420. For example, if a developer creates a new portal event, the name of the portal event and the namespace or namespaces in which it is valid may be recorded in the portal eventing directory. The portal events and namespaces may be based on previously-defined events and/or namespaces as previously described. Multiple portal events may be defined for a namespace, with information about the portal events and namespaces stored in the portal eventing directory. When a developer creates a new portal view 430, the view may include applications, portal events, and other structures. In order to maintain consistency between the new portal events and previously-created portal events, a developer may consult or request information from the portal eventing directory 431. In some cases, the developer may not need to create new portal events or namespaces, and may use events and namespaces already recorded in the portal eventing directory. Based on information on portal events and namespaces in the portal eventing directory, the developer may use namespaces and/or portal events 440 already present in the business system. If there are no appropriate namespaces and/or portal events, the developer may create a new namespace and portal event, new portal events in an existing namespace, or a new namespace and new portal events 450. If the developer creates new namespaces and/or portal events, the developer may use consistent naming based on the information in the portal eventing directory.

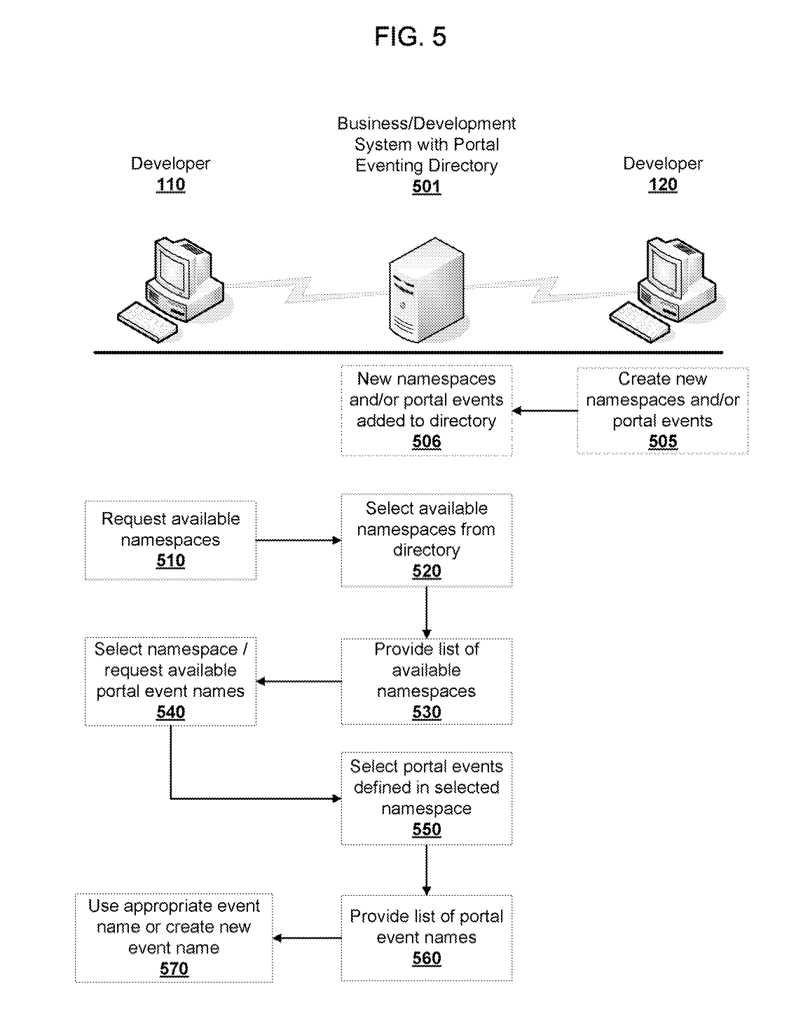

Business and/or development systems having portal eventing directories according to embodiments of the present invention may be used by multiple developers to maintain consistency of portal events and namespaces. The portal eventing directory may be a stored repository of namespaces and portal events, or it may be a system that provides information about namespaces and portal events to developers, for example via an integrated development environment. FIG. 5 shows such a system and a process for using the system. A business and/or development system 501 may have a portal eventing directory. The system 501 may be made of one or more servers and applications. The system may have a separate development system and business system, or the development and business systems may be integrated. The specific arrangement and topology of servers, applications, and systems is irrelevant to the invention unless specified otherwise herein. Developers 110 and 120 may design portal views for use with the business system 501 by communicating with the business and/or development system 501 via a communications network. The specific topology and protocols of the communications network are irrelevant to the invention unless specified otherwise herein.

A developer may create new portal events and/or portal event namespaces 505. Information about the created portal events and/or namespaces may be stored in a portal eventing directory 506. The portal eventing directory may also store relationships between the portal events and the namespaces, such as records of which portal events are valid within each namespace. When a developer creates a new portal view, he may request available namespaces from the portal eventing directory 510. A developer may do so, for example, to determine available namespaces and valid portal events in the context in which he is designing the portal view. The request may be made using any appropriate functions or executable programs. For example, the developer 110 may request available namespaces by navigating through a hierarchy of namespaces displayed in a web browser or other appropriate interface. On receiving such a request, the portal eventing directory may select a list of appropriate namespaces 520 and provide the list to the developer 530. The list may contain additional information, such as the number or nature of portal events defined within each namespace. The list may be selected from a database or any other appropriate storage mechanism. When the developer receives the list of namespaces, he may select an appropriate namespace 540. If no appropriate namespace exists, he may define a new namespace as previously described. The developer may define a new portal event within the selected namespace, or he may request portal events defined in the selected namespace 540. When the portal eventing directory receives such a request, it may select portal events defined within the selected namespace 550 and provide a list of the portal events or portal event names to the developer 560. The developer may then select 570 an appropriate portal event to use in the new portal view. If no appropriate portal event exists, the developer may define a portal event in the selected namespace or in a different namespace as previously described. New portal events and namespaces created by the developer may also be recorded in the portal eventing directory as previously described. Such updates may be done automatically, or they may be done by the developer wishing to create the new namespaces and/or events.

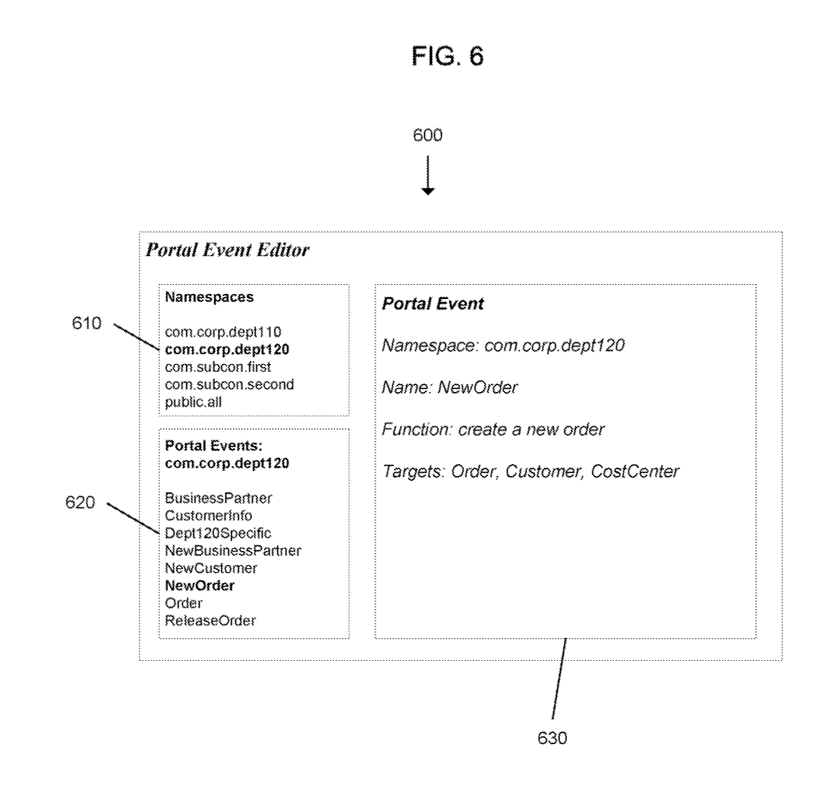

A user interface to a development environment is illustrated in FIG. 6. A developer may use a portal event editor 600 to develop new portal events and portal event namespaces or to modify existing events and namespaces. A portal event or namespace may be edited, for example in a window 630 that displays information about the event or namespace. The editing window may display other information, such as the executable code that defines the event or namespace. The editor may include an interface to a portal eventing directory that provides information about portal events and namespaces. For example, the interface shown in FIG. 6 includes a list of namespaces 610 defined in the business system in which a developer is working. The developer may select one of the namespaces, such as com.corp.dept120, from the list of defined namespaces 610. When the developer selects a namespace, the editor may select valid portal events defined for that namespace from the portal eventing directory, and display the valid portal events in a list 620. The developer may then select one of the portal events, such as NewOrder, and modify it in the editing window 630. Other arrangements of windows, information, and interfaces to the portal eventing directory are possible.

Portal eventing directories according to embodiments of the invention may be restrictive or advisory. That is, developers creating portal events for systems that utilize or include portal eventing directories may be required to follow the namespace and portal event naming schemes defined in or described by the portal eventing directory. The business system and/or portal eventing directory may then prevent developers from creating portal views having portal events that are not consistent with the namespaces and naming conventions defined in the portal eventing directory. For example, a portal system may prevent portal events created outside the scope of the portal eventing directory from being executed. Similarly, the portal eventing directory may only provide information about the namespaces and portal event names stored in the system, without enforcing constraints on developers.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A method for consistency in creating portal events, comprising:
in response to a request by a user, selecting available portal event namespaces;
in response to a selection of a portal event namespace by a user, selecting portal event names that are valid for the selected namespace; and
providing a list of portal event names to a user.

2. The method of claim 1, further comprising:
if a user creates a new portal event having a new portal event name that is not in the list of portal event names, adding the new portal event name to a list of portal event names associated with the selected namespace.

3. The method of claim 1, further comprising:
if a user creates a new portal event having a new portal event name that is not in the list of portal event names, returning an error.

4. A method for maintaining consistency of portal events, comprising:
in response to a definition of a new portal event by a user, comparing the new portal event name to a list of portal event names stored in a portal eventing directory;
if the new portal event name matches one of the portal event names in the portal eventing directory, returning an error; and
if the new portal event name doesn't match any of the portal event names in the portal eventing directory, recording the new portal event name in the portal eventing directory.

5. The method of claim 4 further comprising:
comparing the namespace in which the new portal event is defined to a list of namespaces in the portal eventing directory; and
if the namespace in which the new portal event is defined does not match any namespaces in the portal eventing directory, returning an error or adding the namespace to the list of namespaces in the portal eventing directory.

6. A system comprising:
a development environment for creating portal views;
a portal eventing directory to provide information about portal event namespaces and portal event names;
a user interface to the portal eventing directory to provide portal event name and namespace information to a developer.

7. The system of claim 6, further comprising:
a user interface to display information about portal events defined in a portal event namespace selected by a developer.

8. A machine-readable medium containing program instructions for execution on at least one processor, which when executed by the processor cause the processor to perform:
in response to a request by a user, selecting available namespaces;
providing a list of the available namespaces;
in response to a selection of a namespace by a user, selecting portal event names that are valid for the selected namespace; and
providing a list of portal event names to a user.

9. The machine-readable medium of claim 8, the at least one processor further to perform:
if a user creates a portal event name that is not in the list of portal event names, adding the portal event name to a list of portal event names associated with the selected namespace.

10. The machine-readable medium of claim 8, the at least one processor further to perform:
if a user creates a portal event namespace that is not in the list of namespaces, adding the namespace to a list of available namespaces.
